(19) United States
(12) Patent Application Publication
(10) Pub. No.: US 2013/0251201 A1
(43) Pub. Date: Sep. 26, 2013

(54) SYSTEM AND METHOD FOR RECOMMENDING BUDDIES IN SOCIAL NETWORK

(71) Applicant: SAMSUNG ELECTRONICS CO., LTD., Suwon-si (KR)

(72) Inventor: Lixia ZHOU, Nanjing (CN)

(73) Assignee: Samsung Electronics Co., Ltd., Suwon-si (KR)

(21) Appl. No.: 13/848,302

(22) Filed: Mar. 21, 2013

(30) Foreign Application Priority Data
Mar. 22, 2012 (CN) 201210079045.3
Mar. 13, 2013 (KR) 10-2013-0026675

(51) Int. Cl. G06K 9/00

(52) U.S. Cl. CPC G06K 9/00228
USPC 382/103; 382/195

(57) ABSTRACT

A system for recommending buddies in a social network includes a data management module, a face detection and characteristics extraction module, a face matching module, a user avatar determining module, a buddy recommendation computing module and a buddy recommendation control module. The buddy recommendation control module extracts photo album data of respective users from a data management module, controls the face detection and characteristics extraction module to perform face detection and extraction of face characteristics data, and constructs a photo album face characteristics table comprising extracted face characteristics data for respective users. The buddy recommendation control module controls the user avatar determining module to determine user avatar characteristics of each user and controls the buddy recommendation computing module to generate the buddy recommendation data based on the constructed photo album face characteristics tables, user information and buddy information in the data management modules of respective users.

### CROSS-REFERENCE TO RELATED APPLICATIONS

This application claims the priority benefit of Chinese Application No. 201210079045.3, filed Mar. 22, 2012, in the Chinese Intellectual Property Office and Korean Application No. 10-2013-0026675 filed Mar. 13, 2013 in the Korean Intellectual Property Office, the disclosures of which are incorporated herein by reference.

### BACKGROUND

1. Field

The disclosure herein relates to a system and method for recommending buddies in a social network, and more particularly, to a system and method for recommending matched non-buddy users by detecting and recognizing faces in photos uploaded by users and matching faces with avatars of all users in a social network.

2. Description of the Related Art

Network technology involves merging resources distributed on the Internet into an organic aggregation to achieve overall sharing and organic cooperation of resources, which enables people to transparently make use of the overall capability of the resources and acquire information as needed. Social networks tremendously enrich people's social circle and enable more information and resources to be shared and acquired. Each user may have his/her own sub-network in a social network, that is, as a relationship diagram with buddies around him/her. Buddy recommendation technologies have thus emerged with time.

The existing buddy recommendation technologies are generally based on basic personal literal description information in a social network, including information regarding a user's schools, interests and hobbies. Buddies of other users can be recommended and users near the current online location of a user can be recommended. Under the existing buddy recommendation technologies the accuracy of the recommendation depends on the correctness of the information input by a user to a certain extent.

These buddy recommendation technologies have some limitations. It is difficult for users to find other associated users in other forms. For example, a user A has a group photo, but the user A may not have information related to other people in the group photo. The existing buddy recommendation technologies cannot recommend these other people to become the buddies of the user A.

### SUMMARY

Additional aspects and/or advantages will be set forth in part in the description which follows and, in part, will be apparent from the description, or may be learned by practice of the invention.

An aspect of the present invention is to provide a system and method for recommending buddies by detecting and matching faces in photos (such as photos in albums) uploaded by the users, thereby recommending other users who are not yet buddies of a user but appear in the photos uploaded by the users to a user.

Another aspect of the present invention is to provide a system and method for recommending buddies by detecting and matching faces in the photos (such as photos in albums) uploaded by users, so that if a third user appears in photos of two users but is not yet a buddy of the users, said two users are recommended to one another.

According to one aspect of the present invention, there is provided a system for recommending buddies in a social network, comprising a data management module for managing information of a plurality of users forming the social network, buddy information of the users, and photo album data uploaded by the plurality of users; a face detection and characteristics extraction module for analyzing photos provided from the outside, detecting face areas in the photos, extracting the face characteristics data from the detected face areas and generating a face characteristics table comprising the extracted data; a buddy recommendation computing module for generating buddy recommendation data based on the face characteristics table generated by the face detection and characteristics extraction module, and the user information and buddy information of the respective users in the data management module; a face matching module for determining whether plurality of face characteristics data provided by the buddy recommendation computing module is matched, and returning a matching result to the buddy recommendation computing module; a buddy recommendation control module for providing the photo uploaded by a user to the face detection and characteristics extraction module, for controlling the data management module to store the face characteristics data extracted by the face detection and characteristics extraction module and controlling the buddy recommendation computing module to generate buddy recommendation data, and for providing at least one user with the buddy recommendation information based on the buddy recommendation data.

The system for recommending buddies in a social network may further include a user avatar determining module for determining for each user, user avatar characteristics based on the photo album characteristics table, wherein the buddy recommendation control module controls the data management module to store in the user information, the user avatar characteristics extracted by the user avatar determining module.

The buddy recommendation control module may store a photo album face characteristics table through the data management module.

The buddy recommendation control module may delete the repeated face characteristics data from the photo album face characteristics table.

The buddy recommendation control module may count each face characteristics data in the photo album face characteristics table of each user and may delete the repeated face characteristics data from the photo album face characteristics table of each user when constructing the photo album face characteristics table.

The buddy recommendation computing module may delete the face characteristics data matching the user avatar characteristics of said user or any buddies of said user from the photo album face characteristics table when performing the first process for the photo album face characteristics table of each user.

The buddy recommendation computing module may match each face characteristics data in the photo album face characteristics table with each user avatar characteristics of respective users, and recommends for said user to other users having the matched user avatar information, every time the face matching module returns a positive matching result and the matched user avatar characteristics do not belong to the user himself/herself or any buddy of said user.

The buddy recommendation data generated by the first process and the second process may include different contents, wherein the buddy recommendation data generated in the second process may include photo information extracted from the matched face avatar characteristics data.

If the user avatar determining module determines no preset avatar photo has been set in the photo album data of any user, the user avatar determining module may use the face characteristics data with the highest count extracted from the photo album characteristics table of said user as the user avatar characteristics of said user.

When the buddy recommendation control module receives an instruction of adding a photo to an album for a user, the buddy recommendation control module may control the data management module to add the photo to the photo album data of said user, control the face detection and characteristics extraction module to extract face characteristics data in the photo, add the extracted face characteristics data to the photo album face characteristics table of said user, and control the buddy recommendation computing module to generate buddy recommendation data. The buddy recommendation computing module may perform the first process and the second process for the face characteristics data newly added to the photo album face characteristics table of said user.

When receiving an instruction of adding a buddy for a designated user, the buddy recommendation control module may add the user identification of said buddy to the buddy information of the designated user through the data management module, match the user avatar characteristics of said buddy with the face characteristics data in the photo album face characteristics table of the designated user one by one through the face matching module, and delete the matched face characteristics data from the photo face characteristics table of the designated user.

The system may further include a security control module for selecting and marking photos in a user's photo album data on which analysis and detection are authorized by a user, and when the buddy recommendation control module extracts the photo album data of the user from the data management module, the security control module may only provide the selected photos authorized by the user to the face detection and characteristics extraction module for performing analysis, detection and characteristics extraction.

The face detection and characteristics extraction module may use at least one of the following to perform face detection: a template match model, a skin color model, an active appearance model (AAM), a support vector machine (SVM) model and an Adaboost model, and one of the following methods may be used to perform face characteristics data extraction: template-based characteristics extraction, characteristics extraction based on algebraic methods, characteristics extraction based on flexibility matching, characteristics extraction based on a neural network, and characteristics extraction based on a wavelet multi-resolution. The face matching module may perform matching of face characteristics data using a principal component analysis method.

According to another aspect of the present invention, there is provided a method for recommending buddies in a social network, the method including generating data of each user in the social network, analyzing a photo of each user and extracting face characteristics from the face area of each person, and generating buddy recommendation data by using the extracted face characteristics.

The method for recommending buddies in a social network may further include analyzing a photo of each user and determining user avatar characteristics of the users.

According to another aspect of the present invention, there is provided a method for recommending buddies in a social network comprising analyzing a photo in the photo album of each user in a social network, detecting a face area in the photo, extracting face characteristics data from the face area of each person and constructing a photo album face characteristics table comprising all the face characteristics data extracted from the photos of the photo album; determining face characteristics data extracted from an avatar photo designated by the user in the photo album characteristics table constructed for each user as the avatar characteristics of said user and storing the determined avatar characteristics in the user avatar characteristics item of the user information of said user; matching each face characteristics data in the photo album face characteristics table of said user with the user avatar characteristics of each user one by one, by using the stored user information and buddy information of respective users; and generating buddy recommendation data when the matched user avatar does not belong to the user himself/herself or any buddy of said user.

The photo album face characteristics table may be stored in a database for each user.

The method for recommending buddies in a social network may further include selecting and marking photos in a user's photo album data on which analysis and detection are authorized by the user, and only performing analysis, detection and characteristics extraction of the selected photos, which are authorized to be analyzed and detected, when the photo album data of respective users are extracted.

According to another aspect of the present invention, a server may provide buddy recommendations for users in a network, the server including: a face detection and characteristics extraction module to analyze photos uploaded by users to the network, to extract face characteristics data, and to generate a face characteristics table comprising the extracted data for each user; a user avatar determining module to determine user avatar characteristics of each user; a face matching module to perform a first process by determining whether face characteristics data in a photo album face characteristics table of a first user matches with user avatar characteristics of at least one second user other than buddies of the first user; and a buddy recommendation computing module to generate buddy recommendation data for the first user and the at least one second user, if a positive matching result is obtained in the first process.

The face matching module may perform a second process by determining whether face characteristics data stored in the photo album face characteristics table of the first user matches with face characteristics data stored in a photo album face characteristics table of at least one second user other than buddies of the first user, and the buddy recommendation computing module may generate buddy recommendation data for the first user and the at least one second user, if a positive matching result is obtained in the second process.

The server may further include a buddy recommendation control module which deletes face characteristics data matching the at least one second user from the photo album face characteristics table of the first user, in response to the first user adding the at least one second user as a buddy.

### BRIEF DESCRIPTION OF THE DRAWINGS

The above and other objects and advantages of the present invention will be more apparent from detailed description on embodiments in conjunction with the accompanying drawings, wherein,

FIG. 1 is a logic block diagram illustrating the structure of a system for recommending buddies according to an exemplary embodiment of the present invention;

FIG. 2 is a flowchart illustrating processing in a method for recommending buddies according to an exemplary embodiment of the present invention;

FIG. 3 is a flowchart illustrating processing of generating a photo album face characteristics table according to an exemplary embodiment of the present invention;

FIG. 4 illustrates an example of a photo uploaded by a user according to an exemplary embodiment of the present invention; and

FIG. 5 illustrates an example of photos uploaded by a user according to another exemplary embodiment of the present invention.

### DETAILED DESCRIPTION

The embodiments disclosed herein are described in detail in conjunction with the accompanying drawings to explain the present invention, wherein like reference numerals refer to the like elements throughout.

The modules disclosed herein regarding the system for recommending buddies according to the present invention are not restrictive, and may be re-combined into fewer modules or may be further divided into more modules to realize their functions. In addition, one or more computers/processors of a social network may be equipped with and may execute these modules. For example, a server of a social network may include one or more computers/processors and may be equipped with and can execute these modules. Similarly, the operations disclosed herein regarding the method for recommending buddies according to the present invention are not restrictive either, and may be re-combined into fewer operations or further divided into more operations to realize their functions. Further, some operations may be performed simultaneously with one another, may be performed in a different order, may be performed sequentially, or in parallel.

The system and method for recommending buddies provided according to the present invention may be installed and run using a computer. For example, the system and method for recommending buddies provided according to the present invention may be installed and executed by a server, for example, at the server side of a social network. At least one general inventive concept of the present invention may include analyzing a photo in a photo album of each user, detecting a face area, extracting face characteristics data and constructing a photo album face characteristics table comprising all the extracted face characteristics data for each user; determining the user avatar characteristics of each user based on the photo album face characteristics table of each user; then matching each face characteristics data in the photo album face characteristics table of each user with the user avatar characteristics of all other users in the social network. And, if the matched user avatar characteristics is determined not to belong to said user himself/herself or any buddies of said user, generating buddy recommendation data for recommending a user to which the matched user avatar characteristics pertains to the user whose matched face characteristics data is extracted, and vice versa, so that the user who appears in the photos of other users and is not the buddy of other users yet can be recommended to said other users.

Moreover, each face characteristics data in the photo album face characteristics table of each user may be matched with each face characteristics data in the photo album face characteristics table of all other users so as to generate buddy recommendation data for recommending users who possess matched face characteristics data but are not buddies yet to each other.

Various existing algorithms and models may be employed to perform analysis, detection and face characteristics data extraction of a photo, to match between face characteristics data and match between the face characteristics data and the user avatar characteristics in the present invention. For example, the existing face detection may be performed with a template match model, a skin color model, an active appearance model (AAM), a support vector machine (SVM) model and an Adaboost model, the detection accuracy and speeds of which may be different. Face characteristics data extraction techniques may include template-based characteristics extraction, characteristics extraction based on algebraic methods, characteristics extraction based on flexibility matching, characteristics extraction based on a neural network, and characteristics extraction based on a wavelet multi-resolution. There are various methods for describing face characteristics data, for example, a principal component analysis method (PCA), a linear discriminate analysis method (LDA), local feature analysis method (LFA), and the like, including combinations thereof. Face matching includes substantively calculating face characteristics to obtain a similarity value and matching face characteristics through machine learning. Said technologies of face detection, face characteristics data extraction and face matching are not limited to the above technologies, and those of ordinary skilled in the art may implement the above processes using other algorithms and models, for which the detailed descriptions thereof are not provided in the present application for clearness and conciseness.

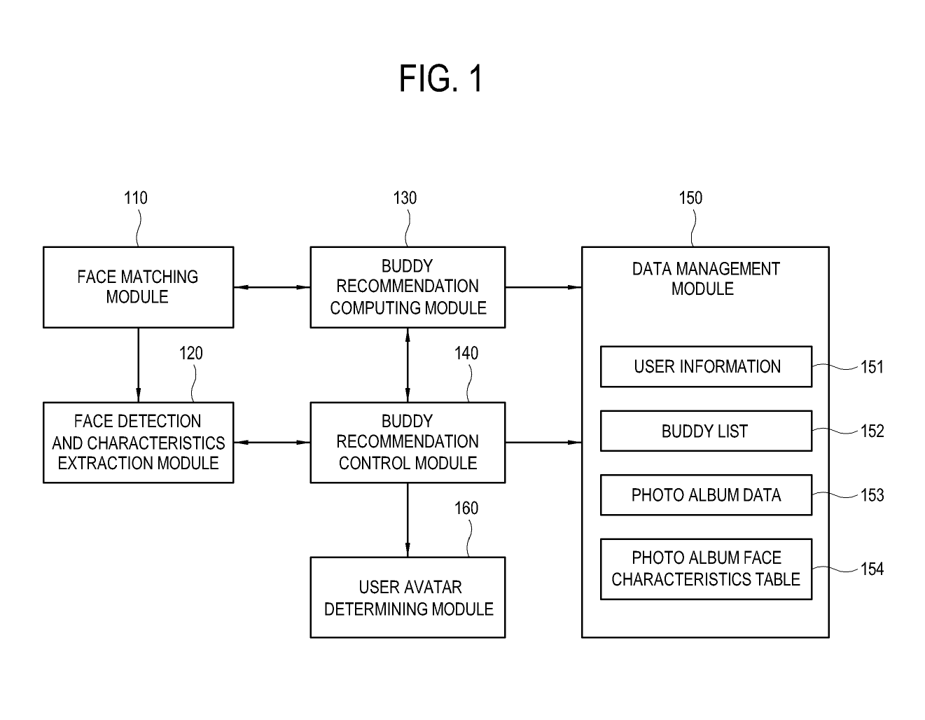

FIG. 1 shows a logic block diagram illustrating the structure of a system for recommending buddies according to an exemplary embodiment of the present invention.

Referring to FIG. 1, the system for recommending buddies according to the present invention includes a face matching module 110, a face detection and characteristics extraction module 120, a user avatar determining module 160, a buddy recommendation computing module 130, a buddy recommendation control module 140 and a data management module 150.

The data management module 150 manages user information 151, buddy list information 152, and photo album data 153, of all users in a social network. A unique user identification may be used to identify each user in the social network. The user information of each user according to the present invention at least comprises user identification and user avatar characteristics, and may further comprise other social information, such as a user's network name, sex, age, marital status, education, residential region and preferences, etc. The initial avatar characteristics of a user may be empty or blank, and the user information may further comprise other information related to the user avatar characteristics. The buddy information of each user at least comprises the user identification of at least one user as the buddies of said user. Generally, a user in a social network can classify his/her own buddies and organize his/her buddies according to classification tags (such as “Family members”, “Classmates”, “Colleagues”, etc.). Buddies who do not have any classification tag can be classified with a default classification tag (e.g., “Ungrouped buddies”). The photo album data of each user may include at least one photo or image uploaded by the user. Here, it is noted that one of ordinary skill in the art would understand a photo or image may be obtained from a movie by analyzing one or more frames from the movie and performing face recognition on the one or more frames from the movie.

The data management module 150 may separately create a table which may include user information, buddy information and photo album data for each user in the managed database and may also separately create a user information table comprising user information of all of users, a buddy information table comprising buddy information of all of users and a photo album information table comprising photo album data of all of users. In the following storage structure, records in each table may include a user identification of the user to whom the record pertains, and the user identification serves as one of the main index items of the table. Of course, storage of the user information, buddy information and photo album data are not limited to the above two storage structures. For example, said information may be organized using other data structures as desired, as long as the user information, buddy information and photo album data of the user can be retrieved with a given user identification. A storage, which may store one or more of the tables disclosed herein, may be realized for example, by a non-volatile memory device such as a read only memory (ROM), a random access memory (RAM), a programmable read only memory (PROM), an erasable programmable read only memory (EPROM), or a flash memory, a volatile memory device such as a random access memory (RAM), or a storage medium such as a hard disk or optical disk. However, the present invention is not limited thereto.

According to a preferred exemplary embodiment of the present invention, the data management module 150 further stores and manages a photo album face characteristics table 154 of each user under the control of the buddy recommendation control module 140. For example, the photo album face characteristics table 154 may include the face characteristics data extracted from the photo album data of the user, to which the photo album face characteristics table pertains.

The face detection and characteristics extraction module 120 analyzes a photo provided by the buddy recommendation control module 140, detects a face area of the photo and extracts face characteristics data from each detected face area.

The face matching module 110 matches a first face characteristics data with a second face characteristics data provided by the buddy recommendation computing module 130 and returns a positive matching result or a negative matching result to the buddy recommendation computing module 130.

In the system of the present invention, the buddy recommendation control module 140 controls other modules to perform corresponding operations according to a received instruction. For example, the buddy recommendation control module 140 may control other modules to perform operations including: controlling the data management module 150 to manage the user information, buddy information and photo album data according to a received user management instruction, a buddy management instruction and a photo album management instruction; extracting the photo album data of each user from the data management module 150 according to a received buddy recommendation instruction; controlling the face detection and characteristics extraction module 120 to detect face areas and extract face characteristics data from the extracted photo album data of each user, thereby constructing a photo album face characteristics table comprising all face characteristics data extracted from the photo album data of said user; controlling the user avatar determining module 160 to determine the user avatar characteristics of each user based on the photo album face characteristics table constructed for each user and store the determined user avatar characteristics in the user avatar characteristics item of the user information of each user (e.g., the determined user avatar characteristics may be stored in the user information table as one of the index items of the table as a user avatar characteristics item and correspond to the respective users); and then controlling the buddy recommendation computing module 130 to generate buddy recommendation data based on the constructed photo album face characteristics tables for some or all of the users, user information and buddy information in the data management module 150.

According to an aspect of exemplary embodiments of the present invention, the buddy recommendation control module 140 may count each face characteristics data in the photo album face characteristics table of each user when constructing a photo album face characteristics table for users. For example, the buddy recommendation control module 140 may count the number of times each face characteristics data appears in the photo album face characteristics table of each user, and may delete repeated face characteristics data from the photo album face characteristics table of each user. The buddy recommendation control module 140 may store the photo album face characteristics table of each user through the data management module 150, so that when a user uploads a new photo, the system is capable of accumulatively generating buddy recommendation data based on the previously constructed photo album face characteristics table of each user. For example, the system may automatically generate buddy recommendation data when a user uploads a photo, or the user may input a command to generate buddy recommendation data when the user uploads the photo. When the system generates buddy recommendation data for a newly uploaded photo, the system may use previously constructed photo album face characteristics table of a user in the photo, in addition to face characteristics data obtained from the newly uploaded photo.

The user avatar determining module 160 determines the face characteristics data extracted from the avatar photo designated by a user in the photo album face characteristics table constructed for each user as the avatar characteristics of said user, and stores the determined avatar characteristics in the user avatar characteristics item of the user information of said user. If it is determined that the user has no designated avatar photo, the user avatar determining module 160 determines the face characteristics data with the highest count extracted from the photo album characteristics table of said user as the user avatar characteristics of said user. That is, for a given user having a number of photos in that user's photo album, a probability may be relatively high that the user's face corresponds to the face which appears most often in the user's photo album.

The buddy recommendation computing module 130 may perform a first process on the photo album face characteristics table of each user by using the user information and buddy information managed by the data management module 150. The first process may be performed, for example, by the face matching module 110 which matches each face characteristics data in the photo album face characteristics table of said user with the user avatar characteristics of each user one by one. Every time the face matching module 110 returns a positive matching result and the matched user avatar characteristics does not belong to said user himself/herself or any buddies of said user, the buddy recommendation computing module 130 may generate buddy recommendation data for recommending said user to the user to which the matched user avatar characteristics pertains. Alternatively, or in addition to such recommendation, the buddy recommendation computing module 130 may generate buddy recommendation data for the user to which the matched user avatar characteristics pertains to said user and recommend said user to the user to which the matched user avatar characteristics pertains. For example a user A may receive a recommendation for potential buddy B, and user B may receive a recommendation for potential buddy A. One or more photos of the user avatar characteristics extracted from the photo album data of the recommended user may be included in the generated recommendation data, for more intuitive recommendation of buddies.

When the buddy recommendation computing module 130 performs the first process with respect to the photo album face characteristics table of each user, the buddy recommendation computing module 130 recognizes the face characteristics data matching the user avatar characteristics of the user himself/herself or any buddy of the user in the photo album face characteristics table of said user. Thus, according to an exemplary embodiment of the present invention, the buddy recommendation computing module 130 deletes the face characteristics data matching the user avatar characteristics of the user himself/herself or any buddy of the user from the photo album face characteristics table.

According to an exemplary embodiment of the present invention, after performing the first process for the photo album face characteristics table of each user, the buddy recommendation computing module 130 may perform a second process on the photo album face characteristics table of each user. For example, the second process may include matching each face characteristics data in the photo album face characteristics table of said user with each face characteristics data in the photo album face characteristics table of all other users through the face matching module 110 one by one, and generating buddy recommendation data of mutual recommendation for said user and the matched said other users every time the face matching module 110 returns a positive matching result. That is, the buddy recommendation computing module 130 may recommend said other matched users to said user and recommending said user to said other matched users. One or more of the photos of the extracted matched face characteristics data may be included in the generated recommendation data for more intuitive recommendation of buddies.

The buddy recommendation computing module 130 may recommend matched users to a user sequentially. That is, the buddy recommendation computing module 130 may first recommend matched users to a user based on a result of the first process, and then recommend matched users to a user based on a result of the second process. Alternatively, the buddy recommendation computing module 130 may recommend matched users to a user based on a combined result of the first process and the second process.

The buddy recommendation computing module 130 stores the buddy recommendation data generated according to the present invention through the data management module 150 so as to display the buddy recommendation data generated for a relevant user when the user refreshes a given page or logs in a next time. Alternatively, the user may enter a command to obtain a buddy recommendation.

When the buddy recommendation control module 140 receives an instruction of adding a photo to an album for a user, the buddy recommendation control module 140 controls the data management module 150 to add the photo to the photo album data of said user, controls the face detection and characteristics extraction module 120 to extract face characteristics data in the photo, adds the extracted face characteristics data to the photo album face characteristics table of said user and controls the buddy recommendation computing module 130 to generate buddy recommendation data, wherein the buddy recommendation computing module 130 performs the first process and may also perform the second process for the face characteristics data newly added to the photo album face characteristics table of said user.

When receiving an instruction of adding a buddy for the designated user, the buddy recommendation control module 140 adds the user identification of said buddy into the buddy information of the designated user through the data management module 150, matches the user avatar characteristics of said buddy with the face characteristics data in the photo album face characteristics table of the designated user one by one through the face matching module 110 and deletes the matched face characteristics data from the photo face characteristics table of the designated user.

According to an exemplary embodiment of the present invention, the system further comprises a security control module (not shown) for selecting and marking photos on which the user authorizes to perform analysis and detection in his/her photo album data. That is, a user may restrict or limit the number of photos which may be analyzed for face detection and extraction of facial characteristics. When the buddy recommendation control module 140 extracts the photo album data of respective users from the data management module 150, the security control module may provide only those photos authorized for analysis and detection to the face detection and characteristics extraction module 120 for performing analysis, detection and characteristics extraction.

It can be seen by referring to the above description of FIG. 1, the system for recommending buddies in a social network according to the present invention can perform face detection and characteristics extraction from a photo (such as the photos in the photo album or images from a movie) uploaded by a user in a social network. A user who appears in the photo of another user, but is not yet the buddy of the other user can be recommended by matching the face characteristics extracted from the photo uploaded by the user with the user avatar characteristics of other users. In addition, the system for recommending buddies according to the present invention matches the face characteristics data extracted from photos of the photo albums of all users one by one and mutually recommends two users to each other, who are not buddies yet but a same person may appear in both their photo albums.

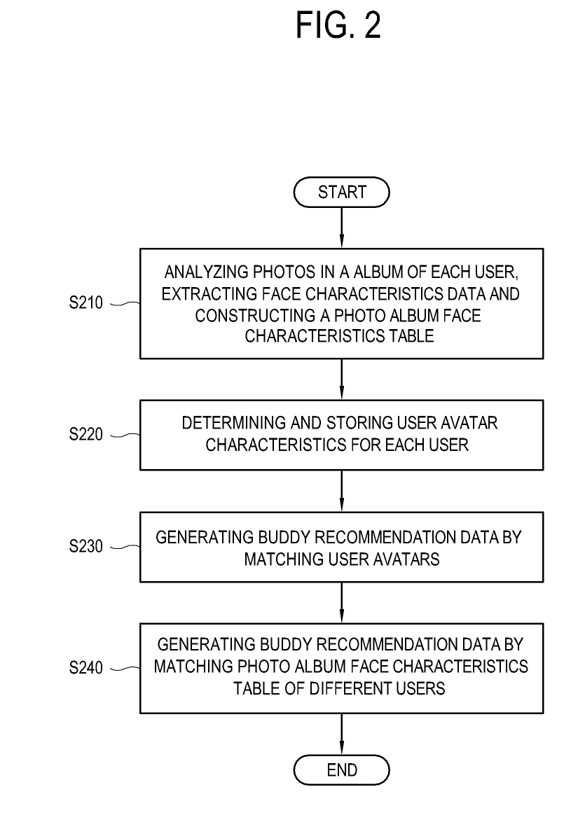

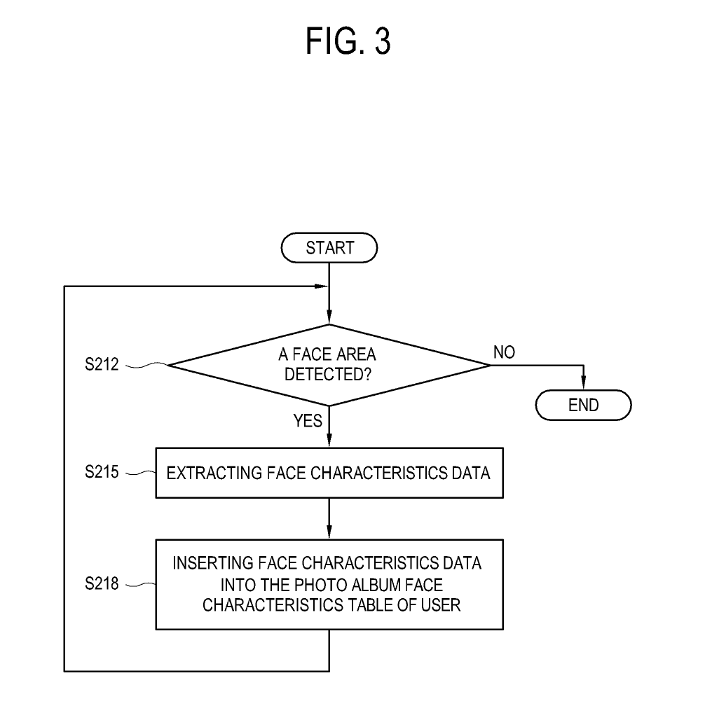

The method for recommending buddies in a social network according to the present invention is described in details in reference with FIGS. 2 and 3. The method is implemented in the system as illustrated in FIG. 1. For example, the method may implement using a server, e.g., at the server side of a social network. As mentioned above, user information, buddy information and photo album data of a user are stored for each user in a social network in the system of the present invention, the user information comprises user identification and user avatar characteristics, and the buddy information comprises at least one user identification of buddies.

FIG. 2 is a flowchart illustrating processing in a method for recommending buddies according to an exemplary embodiment of the present invention.

Referring to FIG. 2, in operation S210, the system performs face detection and analysis on photos or images in the photo album data of each user in a social network, detects a face area in a photo, extracts the face characteristics data from each detected face area and constructs a photo album characteristics table comprising all of the face characteristics data extracted from the photos in the photo album for each user. Face detection may be performed, for example, by using an algorithm or by a user identifying a face area in a photo to be analyzed, or a combination thereof of an algorithm and a user input. FIG. 3 illustrates performing face detection and analysis for a given photo of any user and the process of extracting face characteristics data in operation S210. In operation S212, analysis and face detection on a given photo is performed and whether a face area is detected in the given photo is determined. If a face area is detected, in operation S215, the system extracts the face characteristics data from the detected face area according to a predetermined algorithm. Then, in operation S218, the system inserts the extracted face characteristics data into the photo album face characteristics table of said user. On the other hand, if no face area is detected in the given photo in operation S210, the system completes the process of the given photo. The process as illustrated in FIG. 3 is performed on each photo in the photo album data of each user in the social network. Additionally, as can be seen from FIG. 3, the process may be repeated for each face which is detected in a photo, when there are a plurality of faces in a single image or photo.

According to a preferred exemplary embodiment of the present invention, the system counts each face characteristics data in the photo album face characteristics table of each user. For example, the system may count the number of times each face characteristics data appears in the photo album face characteristics table of said user during the process of constructing the photo album face characteristics table for each user, and deletes the repeated face characteristics data from the photo album face characteristics table of each user. Moreover, the system stores the photo album face characteristics tables of respective users in a nonvolatile storage medium.

In operation S220, the system determines face characteristics data extracted from the avatar photo designated by a user in the photo album face characteristics table constructed for each user as the avatar characteristics of said user, and stores the determined avatar characteristics in the user avatar characteristics item of the user information of said user. If it is determined that the user has no designated avatar photo, the face characteristics data with the highest count extracted from the photo album characteristics table of said user may be determined as the user avatar characteristics of said user, and the determined avatar characteristics may be stored in the user avatar characteristics item in the user information of the user.

Then in operation S230, the system performs a first process for the photo album face characteristics table of each user, the first process including matching each face characteristics data in the photo album face characteristics table of said user with the user avatar characteristics of each user one by one using the stored user information and buddy information of respective users, and generating the buddy recommendation data for mutual recommendation for said user and the user to which the matched user avatar characteristics pertains, every time a positive matching result is returned and the matched user avatar does not belong to the user himself/herself or any buddy of said user. For example, the system may recommend the user to which the matched user avatar characteristics pertains to said user and may recommend said user to the user to which the matched user avatar characteristics pertains. The photo of the user avatar characteristics extracted from the photo album data of the recommended user may be included in the generated recommendation data for more intuitive recommendation of buddies. Accordingly, the other user appearing in a photo album of any user in a social network, who is not the buddy of the user yet, may be recommended to the user, and vice versa.

Preferably, the system deletes the face characteristics data matching the user avatar characteristics of the user or any buddy of the user from the photo album face characteristics table of the user.

On such basis, according to another exemplary embodiment of the present invention, the system performs a second process (operation S240) for the photo album characteristics table of each user after performing the first process on the photo album characteristics table of each user, said second process including matching each face characteristics data in the photo album face characteristics table of said user with each face characteristics data in the photo album face characteristics table of all other users one by one, and generating the buddy recommendation data for mutual recommendation for said user and the matched said other users every time the face matching module returns a positive matching result, that is, recommending said other matched users to said user and recommending said user to said other matched users. One or more of the photos of the extracted matched face characteristics data may be included in the generated recommendation data for more intuitive recommendation of buddies. Information regarding a potential buddy's name, age, sex, schools, occupation, marital status, interests, and/or hobbies, etc. may also be retrieved and provided to the user to assist the user in confirming that the potential buddy shown in the photo of the extracted matched face characteristics data is the same person as in the photo in the photo album of the user. Accordingly, users having photo albums in which a same person appears can be associated and mutually recommended.

According to another exemplary embodiment of the present invention, when receiving an instruction of adding a photo to an album for a user, the system adds the photo to the photo album data of said user, extracts face characteristics data from the photo by the face detection and characteristics extraction module, adds the extracted face characteristics data to the photo album face characteristics table of said user, performs the first process and optionally performs the second process for the face characteristics data newly added to the photo album face characteristics table of said user.

According to another exemplary embodiment of the present invention, when receiving an instruction of adding a buddy for a designated user, the system adds the user identification of said buddy to the buddy information of the designated user, matches the user avatar characteristics of said buddy with the face characteristics data in the photo album face characteristics table of the designated user one by one and deletes the matched face characteristics data in the returned match result from the photo face characteristics table of the designated user.

According to an exemplary embodiment of the present invention, the system further marks selected photos on which analysis and detection are authorized by the user in his/her photo album data and performs analysis, detection and characteristics extraction only for those selected photos, when extracting the photo album data of respective users.

It can be seen from the above description in conjunction with FIGS. 1 through 3, the system and method for recommending buddies in a social network according to the present invention, performs face detection and characteristics extraction on photos (such as the photos in the photo album) uploaded by a user in a social network, and a user who appears in a photo of another user but is not the buddy of the other user yet can be recommended by matching the face characteristics extracted from the photo uploaded by the user with the user avatar characteristics of all users. In addition, the system for recommending buddies according to the present invention matches the face characteristics data extracted from photos of the photo albums of all users one by one and mutually recommends two users to each other, who are not buddies yet, if a same person appears in photo albums of both users, thereby further improving correlation of users.

For example, user A and user B may appear in a first photo stored in the photo album of user A. User A may not have the conventional information needed regarding user B to add user B to user A's buddy list. According to the present invention, user B's face may be detected from the first photo, face characteristics data may be extracted, and the face characteristics data corresponding to user B may be inserted into a photo album face characteristics table of user A. A match may be made between the face characteristics table of user A and one or more of the avatars of all other users (excluding user A and buddies of A). Alternatively, or in addition to, a match may be made between the face characteristics table of user A and one or more of the face characteristics tables of all other users (excluding user A and buddies of A). Through the above process, a positive matching result may be obtained. For example, user B may have a photo of himself/herself in user B's photo album or as an avatar, noting that the avatar photo may be stored in the photo album of user B. Thus, a match may be made since user B appears in each of the photo albums belonging to user A and user B. Accordingly, user B may be recommended to user A as a potential buddy, and user A may be recommended to user B as a potential buddy.

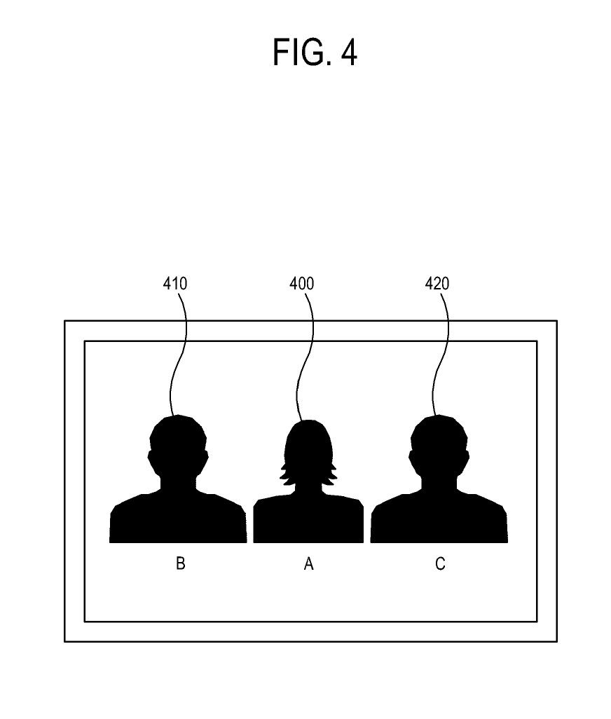

FIG. 4 illustrates an example of a photo uploaded by a user according to an embodiment of the present invention. As shown therein, in the case where a user A 400 takes a photograph of buddies B and C 410 and 420 and uploads the photo, a buddy recommendation process will be explained. The above case refers to the case where a buddy list 152 and a photo album face characteristic table 154 of the user A 400 include the information of the buddies B and C. That is, the buddy list 152 of the user A 200 includes information of the buddy B 410 and information of the buddy C 420, and the photo album face characteristic table 154 includes avatar information of the buddies together with the face characteristic information of the buddy B 410 and the buddy C 420, but the buddy B 410 or the buddy C 420 is not set as a buddy in the data management module 150.

The buddy recommendation control module 140 controls the face detection and characteristics extraction module 120 to detect face areas in the photo and extract the face characteristics from the detected face areas of each person. The buddy recommendation control module 140 also checks user information 151, a buddy list 152, photo album data 153 and a photo album face characteristics table 154 in the data management module 150 to determine whether the buddies B and C 410 and 420 are in the buddy list 152. If it is determined that the buddies B and C 410 and 420 are not buddies with each other, the buddy recommendation control module 140 controls the user avatar determining module 160 to generate avatars suitable for the buddies B and C 410 and 420 and to generate buddy recommendation data including the avatars. That is, the buddy recommendation control module 140 provides the buddy B 410 with data recommending the buddy C 420, and provides the buddy C 420 with data recommending the buddy B 410.

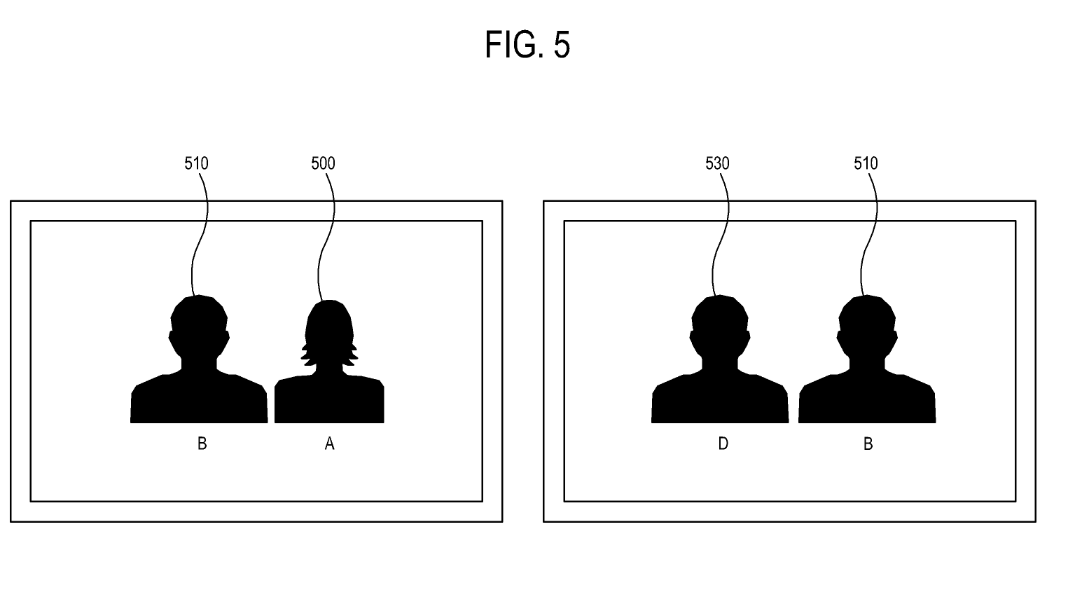

FIG. 5 is an example of photos uploaded by a user according to another exemplary embodiment of the present invention. Unlike the exemplary embodiment in FIG. 4, the exemplary embodiment in FIG. 5 relates to the buddy recommendation using two photos uploaded by the same user B 510. That is, the exemplary embodiment explains the case where the user B 510 uploads the photo taken with the buddy A 500, and the case where the user B 510 uploads the photo taken with a buddy D 530.

Through a similar process as above, the buddy recommendation control module 140 controls the user avatar determining module 160 to generate avatars suitable for the buddies A and D 500 and 530 and generates buddy recommendation data including the avatars. That is, the buddy recommendation control module 140 provides the buddy A 500 data recommending the buddy D 530, and provides the buddy D 530 data recommending the buddy A 200. That is, two images contain a same user (buddy B 510), in which buddies A and D 500 and 530 appear. Therefore, the system may determine that because buddy B appears in a photograph with buddy A and buddy B also appears in a photograph with buddy D, buddy A and buddy D may wish to be socially connected if they are not already buddies with one another.

The effect of the embodiments disclosed herein may be as follows:

Firstly, a user may form a social network with various people.

Secondly, a user may make friends with other users who are not yet buddies of the user but appear in the photos uploaded by the user. Further, users who do not upload the photos themselves may receive buddy recommendations to other users, in which the other users appear in photographs with a common person.

The apparatus and methods used to perform a buddy recommendation according to the above-described example embodiments may use one or more processors, which may include a microprocessor, central processing unit (CPU), digital signal processor (DSP), or application-specific integrated circuit (ASIC), as well as portions or combinations of these and other processing devices.

The terms “module”, and “unit,” as used herein, may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Each block of the flowchart illustrations may represent a unit, module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The apparatus and methods according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

The present invention is illustrated and described in reference with exemplary embodiments as disclosed herein. However, those skilled in the art will understand that various modifications and changes may be made to the above-described embodiments without departing from the scope and spirit of the invention, the scope of which is defined with the accompanying claims and their equivalents.

What is claimed is:

1. A system for recommending buddies in a network, comprising:
a data management module to manage information of a plurality of users forming the network, buddy information of the users, and photo data uploaded by the plurality of users;
a face detection and characteristics extraction module to analyze photos, to detect face areas in the photos, to extract face characteristics data from the detected face areas, and to generate a face characteristics table comprising the extracted data;
a buddy recommendation computing module to generate buddy recommendation data based on the generated face characteristics table, and user information and buddy information of the respective users in the data management module; and
a face matching module to determine whether the face characteristics data provided by the buddy recommendation computing module is matched, and to return a matching result to the buddy recommendation computing module.

2. The system of claim 1, further comprising:
a buddy recommendation control module to provide a photo uploaded by a user to the face detection and characteristics extraction module, to control the data management module to store the face characteristics data extracted by the face detection and characteristics extraction module, to control the buddy recommendation computing module to generate buddy recommendation data, and to provide at least one user with buddy recommendation information based on the buddy recommendation data.

3. The system of claim 2, further comprising:
a user avatar determining module to determine for each user, user avatar characteristics based on the photo album characteristics table, wherein the buddy recommendation control module controls the data management module to store in the user information the user avatar characteristics extracted by the user avatar determining module.

4. The system of claim 3, wherein the buddy recommendation control module deletes repeated face characteristics data from the photo album face characteristics table.

5. The system of claim 1, wherein the buddy recommendation computing module matches each face characteristics data in the photo album face characteristics table with avatar characteristics of respective users, and recommends a user to other users having the matched user avatar information, every time the face matching module returns a positive matching result and the matched user avatar characteristics do not belong to the user or any buddy of the user.

6. The system of claim 3, wherein if the user avatar determining module determines no preset avatar photo has been set in the photo album data of a first user, the user avatar determining module uses the face characteristics data with the highest count extracted from the photo album characteristics table of the first user as the user avatar characteristics of the first user.

7. The system of claim 1, further comprising:
a security control module to provide selected photos from among the photo data uploaded by a user, which are authorized by the user to the face detection and characteristics extraction module.

8. The system of claim 1, wherein the face detection and characteristics extraction module uses at least one of the following to perform face detection: a template match model, a skin color model, an active appearance model (AAM), a support vector machine (SVM) model and an Adaboost model.

9. The system of claim 1, wherein the face detection and characteristics extraction module uses at least one of template-based characteristics extraction, characteristics extraction based on algebraic methods, characteristics extraction based on flexibility matching, characteristics extraction based on a neural network, and characteristics extraction based on a wavelet multi-resolution to extract face characteristics.

10. The system of claim 1, wherein the face matching module performs matching of face characteristics data using a principal component analysis method.

11. The system of claim 1, wherein the buddy recommendation control module controls the face detection and characteristics extraction module to detect face characteristics of at least two users included in a single photo other than a third user included in the single photo, checks buddy information through the data management module, and performs buddy recommendation for the at least two users other than the third user.

12. The system of claim 1, wherein the buddy recommendation control module controls the face detection and characteristics extraction module to detect face characteristics of a second user while excluding a first user included in a first photo, and to detect face characteristics of a third user included in a second photo while excluding the first user included in the second photo, checks buddy information through the data management module, and performs buddy recommendation for the second and third users.

13. A method for recommending buddies in a social network, comprising:
generating data of each user in the social network;
analyzing a photo of each user and extracting face characteristics from the face area of each person; and
generating buddy recommendation data by using the extracted face characteristics.

14. The method of claim 13, further comprising:
analyzing a photo of each user and determining user avatar characteristics of the users.

15. A method for recommending buddies in a network comprising:
analyzing a photo in the photo album of each user in the network, detecting a face area in the photo, extracting face characteristics data from the face area of each person and constructing a photo album face characteristics table comprising face characteristics data extracted from the photos of the photo album;
determining face characteristics data extracted from an avatar photo of each user in the network and storing the determined avatar characteristics in a user information table as an user avatar characteristics item; matching each face characteristics data in the photo album face characteristics table of a first user with the user avatar characteristics of each user in the network one by one, by using the stored user information and buddy information of respective users; and
generating buddy recommendation data when the matched user avatar does not belong to the first user or any buddy of the first user.

16. The method of claim 15, wherein the photo album face characteristics table is stored in a database for each user.

17. The method of claim 15, further comprising counting each face characteristics data in the photo album face characteristics table of each user and deleting repeated face characteristics data from the photo album face characteristics table of each user.

18. The method of claim 15, further comprising
matching each face characteristics data in the photo album face characteristics table of the first user with each face characteristics data in the photo album face characteristics table of all other users one by one, and generating buddy recommendation data.

19. The method of claim 15, wherein, the buddy recommendation data comprise different contents.

20. The method of claim 15, wherein the buddy recommendation data comprise photo information extracted from the matched face avatar characteristics data.

21. The method of claim 15, wherein, if it is determined that there is no designated avatar photo in the photo album data of a user, determining the face characteristics data with the highest count extracted from the photo album characteristics table of said user as the user avatar characteristics of said user.

22. The method of claim 15, further comprising:
receiving information from a user regarding authorization for analysis and detection with respect to one or more photos in the photo album data of the said user.

23. The method of claim 15, wherein at least one of the following modules is used to perform face detection: a template match model, a skin color model, an active appearance model (AAM), a support vector machine (SVM) model and an Adaboost model.

24. The method of claim 15, wherein at least one of the following methods is used to perform face characteristics extraction: template-based characteristics extraction, characteristics extraction based on algebraic methods, characteristics extraction based on flexibility matching, characteristics extraction based on a neural network, and characteristics extraction based on a wavelet multi-resolution.

25. The method claim 15, further comprising:
performing match of face characteristics data using a principal component analysis method.

26. A server to provide buddy recommendations for users in a network, comprising:
a face detection and characteristics extraction module to analyze photos uploaded by users to the network, to extract face characteristics data, and to generate a face characteristics table comprising the extracted data for each user;
a user avatar determining module to determine user avatar characteristics of each user;
a face matching module to perform a first process by determining whether face characteristics data in a photo album face characteristics table of a first user matches with user avatar characteristics of at least one second user other than buddies of the first user; and
a buddy recommendation computing module to generate buddy recommendation data for the first user and the at least one second user, if a positive matching result is obtained in the first process.

27. The server of claim 26, wherein:
the face matching module performs a second process by determining whether face characteristics data stored in the photo album face characteristics table of the first user matches with face characteristics data stored in a photo album face characteristics table of at least one second user other than buddies of the first user; and
the buddy recommendation computing module generates buddy recommendation data for the first user and the at least one second user, if a positive matching result is obtained in the second process.

28. The server of claim 26, further comprising:
a buddy recommendation control module to delete face characteristics data matching the at least one second user from the photo album face characteristics table of the first user, in response to the first user adding the at least one second user as a buddy.
